(19) United States
(12) Patent Application Publication
(10) Pub. No.: US 2018/0198544 A1
(43) Pub. Date: Jul. 12, 2018

(54) CONTENT PROVIDER NETWORK INTERFACE

(71) Applicant: QUALCOMM Incorporated, San Diego, CA (US)

(72) Inventors: Gordon Kent Walker, Poway, CA (US); Charles Nung Lo, San Diego, CA (US); Alan Soloway, Erie, CO (US); Thomas Stockhammer, Bergen (DE)

(21) Appl. No.: 15/845,783

(22) Filed: Dec. 18, 2017

Related U.S. Application Data
(60) Provisional application No. 62/445,149, filed on Jan. 11, 2017.

(51) Int. Cl. H04H 60/64; H04H 60/66; H04L 29/08

(52) U.S. Cl. CPC H04H 60/64; G06Q 30/0277; H04L 67/16; H04H 60/66

(57) ABSTRACT

Systems and methods providing a robust network interface to facilitate an understanding of the network by an external party or entity, such as a content provider, without disclosing network configuration details are described. In operation of a network interface of embodiments, a content provider system is able to obtain robust network information and facilitate ad sales via automated interfaces, wherein descriptions of ad avail opportunities that include information regarding the geographic area and potential target device population are provided.

### CROSS-REFERENCE TO RELATED APPLICATIONS

This application claims the benefit of U.S. Provisional Patent Application No. 62/445,149, entitled, “CONTENT PROVIDER NETWORK INTERFACE,” filed on Jan. 11, 2017, the disclosure of which is hereby incorporated by reference herein in its entirety as if fully set forth below and for all applicable purposes.

### FIELD

This disclosure generally relates to the providing of content to network nodes. More specifically, this disclosure relates to a robust network interface between a content provider and a network comprising network nodes to which content is to be provided.

### BACKGROUND

Various Content Providers (CPs) may provide content for consumption by user devices, such as by broadcast, multicast, and/or unicast communication via one or more networks. For example, an entity or individual originally sourcing content, such as multimedia content, may transmit streaming content to one or more user devices and thus operate as a content provider. Similarly, a Multichannel Video Programming Distributor (MVPD), such as may comprise a cable or satellite service provider, may provide redistribution of content originally broadcast over the air to one or more user devices and thus operate as a content provider. Irrespective of the particular paradigm in which a CP obtains and provides content, the CPs may utilize networks of a Mobile Network Operator (MNO) or other network operator (referred to collectively as Network Operators (NOs)) to facilitate delivery of content to a variety of users, such as may comprise customers or subscribers of the CP and/or MNO, various nodes within the MNO's network, etc.

As can be appreciated from the foregoing, a network as operated by a NO may provide an interface to a CP through which the above mentioned content may be transmitted to various user devices of the network. However, the NO is generally unwilling to disclose certain proprietary information in association with the network interface to the CPs, such as the exact or detailed configuration of their network.

A portion of the CP's revenue may be derived from delivery of advertisements (referred to as ads) delivered to consumers of the content. The potential revenue for delivery of such ads may be dependent, at least in part, on the ability to target ads to particular users, groups of users, etc., the ability to confirm delivery of ads to user equipment, and the like. Accordingly, the CP may have interest in various information regarding the network, users, and/or user equipment to which content is or may be delivered, such as the geographic area(s) covered, the users and/or user equipment served or available for service, etc.

Although the interface provided with respect to the CP and NO may comprise media and service composition description, service area selection, and description of ad slot availability, the description on the interface may not or does not need to disclose internal NO or CP architecture. For example, the interface description may comprise a written Service Level Agreement (SLA) in which the NO describes the level of service (e.g., minimum bit rate and maximum bit rate) that the NO will meet within the service area. That is, the interface description would provide the service and capability on offer from the NO without disclosing the network configuration or providing information regarding particulars of the users identities or user equipment of the network.

### SUMMARY

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for interfacing a content provider system with a broadcast network is provided. The method of embodiments includes coupling the content provider system to a gateway interface configured to enable the content provider system to request broadcast service area information of the broadcast network and to provide network information including the broadcast service area information to the content provider system facilitating an understanding of the broadcast network by the content provider system without disclosing configuration details of the broadcast network to the content provider system. The method of embodiments further includes providing, by the gateway interface in response to a request for the broadcast service area information from the content provider system, a broadcast service area response message comprising at least a portion of the network information to the content provider system, wherein the at least a portion of the network information includes the broadcast service area information.

In another aspect of the disclosure, an apparatus configured for interfacing a content provider system with a broadcast network is provided. The apparatus of embodiments includes means for coupling the content provider system to a gateway interface configured to enable the content provider system to request broadcast service area information of the broadcast network and to provide network information including the broadcast service area information to the content provider system facilitating an understanding of the broadcast network by the content provider system without disclosing configuration details of the broadcast network to the content provider system. The apparatus of embodiments further includes means for providing, by the gateway interface in response to a request for the broadcast service area information from the content provider system, a broadcast service area response message comprising at least a portion of the network information to the content provider system, wherein the at least a portion of the network information includes the broadcast service area information.

In yet another aspect of the disclosure, a non-transitory computer-readable medium having program code recorded thereon for interfacing a content provider system with a broadcast network is provided. The program code of embodiments includes program code executable by a computer for causing the computer to interface the content provider system to a gateway configured to enable the content provider system to request broadcast service area information of the broadcast network and to provide network information including the broadcast service area information to the content provider system facilitating an understanding of the broadcast network by the content provider system without disclosing configuration details of the broadcast network to the content provider system. The program code of embodiments further includes program code executable by the computer for causing the computer to provide, by the gateway interface in response to a request for the broadcast service area information from the content provider system, a broadcast service area response message comprising at least a portion of the network information to the content provider system, wherein the at least a portion of the network information includes the broadcast service area information.

In still another aspect of the disclosure, an apparatus configured for interfacing a content provider system with a broadcast network is provided. The apparatus of embodiments includes a memory and at least one processor coupled to the memory. The at least one processor of embodiments is configured to interface the content provider system to a gateway configured to enable the content provider system to request broadcast service area information of the broadcast network and to provide network information including the broadcast service area information to the content provider system facilitating an understanding of the broadcast network by the content provider system without disclosing configuration details of the broadcast network to the content provider system. The at least one processor of embodiments is further configured to provide, by the gateway interface in response to a request for the broadcast service area information from the content provider system, a broadcast service area response message comprising at least a portion of the network information to the content provider system, wherein the at least a portion of the network information includes the broadcast service area information.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the disclosed system and methods, reference is now made to the following descriptions taken in conjunction with the accompanying drawings.

FIG. 1 shows an exemplary implementation of an interface according to aspects of the present disclosure.

FIG. 2 shows an example of polygons as may be utilized to provide descriptions of covered areas according to aspects of the present disclosure.

FIGS. 3A-3C show exemplary schemas for operation of a system using an interface according to aspects of the present disclosure.

FIG. 4 shows an exemplary schema depiction of a device type pair description according to aspects of the present disclosure.

FIG. 5 shows services defined by collections of service components according to aspects of the present disclosure.

FIG. 6 shows an exemplary schema depiction of a component level description according to aspects of the present disclosure.

FIGS. 7A and 7B show exemplary schema depictions of service area response messages according to aspects of the present disclosure.

FIGS. 8A and 8B show exemplary schema depictions of service request messages according to aspects of the present disclosure.

FIGS. 9A and 9B show exemplary XML schema depictions of service offer messages according to aspects of the present disclosure.

FIG. 10 shows an exemplary configuration of ad avail description documents according to aspects of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the term “content” may include data having video, audio, combinations of video and audio, or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in this description, the term “streaming content” refers to content that may be sent from a server device and received at a user device according to one or more standards that enable the real-time transfer of content or transfer of content over a period of time. Examples of streaming content standards include those that support de-interleaved (or multiple) channels and those that do not support de-interleaved (or multiple) channels.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

As used herein, the terms “user equipment,” “user device,” and “client device” include devices capable of receiving content from a server, such as, for example, a web server, and transmitting information to the server. Such devices can be stationary devices or mobile devices. The terms “user equipment,” “user device,” and “client device” can be used interchangeably.

As used herein, the term “user” refers to an individual receiving content on a user device or on a client device and transmitting information via the client device.

Systems and methods disclosed herein provide a robust network interface to facilitate an understanding of the network by an external party or entity, such as a CP, without disclosing network configuration details. For example, a robust network interface (referred to herein as a CP/network interface) may be implemented between a content provider and a network comprising network nodes to which content is to be provided according to the concepts herein. In operation of a CP/network interface of embodiments of the present disclosure, a CP system is able to obtain robust network information (i.e., including coverage and usage metrics facilitating an understanding of the network by an external party or entity without disclosing network configuration details) and facilitate ad sales via automated interfaces, enabling the CP and/or NO to effectively sell ads. Descriptions of the ad avail opportunities are provided by embodiments that include information regarding the geographic area and potential target device population.

In accordance with embodiments of the disclosure, the NO may disclose, through the CP/network interface, information regarding the area(s) that can be covered (referred to herein as service area information) and information regarding the nature of the coverage provided (referred to herein as coverage nature information), such as the bit rate (e.g., average bit rate, maximum bit rate, etc.) and percentage coverage at a specific service grade (e.g., the service grade may be represented by an N dimensional vector and may be defined differently for various reception conditions and device types, such as to provide layered components within a service) for supported services (e.g., a service may be defined by a collection of service components, wherein one or more service components might not be delivered for all combinations of reception condition and device types). The coverage nature information provided according to embodiments of the disclosure may comprise information regarding the currently available and reachable receivers (referred to herein as service population characteristic information). For example, the service population characteristic information of embodiments includes the numbers and types of the currently reachable receivers, devices, and/or other user equipment (e.g., reachable user equipment having data connectivity and capable of taking and reporting an ad if one were delivered). The service population characteristic information may further include the numbers and types of the potential receivers, devices, and/or other user equipment (e.g., user equipment currently present on a specific service although perhaps not currently engaging in connectivity to report an ad if one were delivered). Service population characteristic information of embodiments may additionally or alternatively include information of a demographic nature for the user equipment or users thereof. It should be appreciated that, in providing coverage nature information and service population characteristic information in accordance with embodiments herein, the exact identity of the user equipment instances need not be disclosed to the CP system, but rather a collection of their attributes are disclosed. Accordingly, although the network knows or may know the unique identity of the unicast connected devices, for example, this information is not disclosed to the CP system or need not be known according to embodiments of the present disclosure.

In operation of a CP/network interface implementation of embodiments herein, the NO has no obligation to reveal the network architecture or the method of delivery to any receiver to the CP on the interface. Nevertheless, the NO may provide or allow the collection of information on the viewership for user equipment that support report back and may be connected during transmission of content (e.g., an ad, show, etc.) by the CP via the CP/network interface. This information may, for example, be collected directly by the NO and/or by a CP, such as via an application on target user equipment.

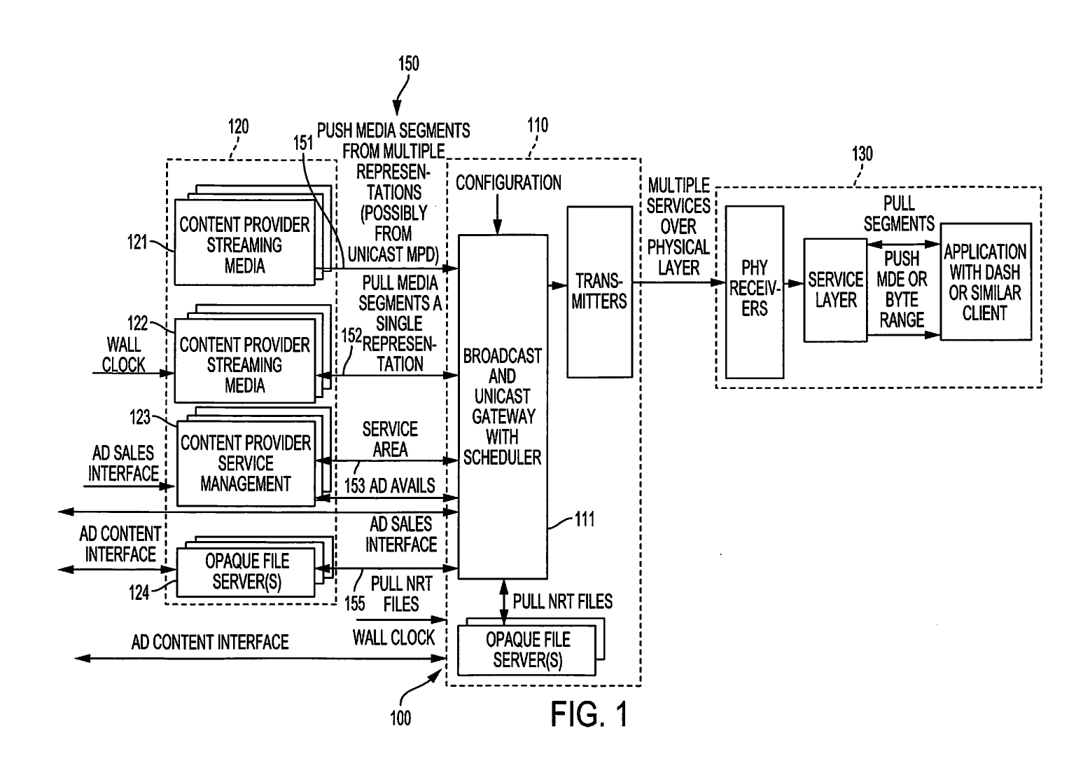

FIG. 1 shows an exemplary implementation of a CP/network interface according to embodiments of the present disclosure. In particular, FIG. 1 shows communication system 100 in which CP system 120 provides content to user equipment 130 via network 110 using a CP/network interface configuration implemented according to concepts of the present disclosure.

CP system 120 of FIG. 1 may, for example, comprise one or more servers (e.g., web servers, media servers, file servers, etc.) operable to provide various services to client devices, such as user equipment 130. For example, CP system 120 of embodiments may provide transmission of streaming content, such as through broadcast transmission, multicast transmission, and/or unicast transmission provided by one or more of media servers 121 and 122. CP system 120 may further operate to facilitate the providing of additional information or content, such as advertising content under control of service and ad management control logic 123, to the client devices in association with delivered content. Although a single CP system is shown in the illustrated embodiment of FIG. 1 for simplicity, it should be appreciated that communication system 100 may comprise a plurality of CP systems, whether having the same or different configurations as that shown, being associated with a same CP entity or different CP entities, or combinations thereof.

User equipment 130 of FIG. 1 may, for example, comprise one or more processor-based client device configurations (e.g., smart phone, computer, personal digital assistant (PDA), tablet device, media player, Internet appliance, Internet of Things (IoT) device, smart television, set-top-box, etc.) operable to receive content and/or other information as may be provided from time to time by systems such as CP system 120. Although a single user equipment instance is shown in the illustrated embodiment of FIG. 1 for simplicity, it should be appreciated that communication system 100 may comprise a plurality of user equipment instances, whether having the same or different configurations as that shown, being associated with a same user entity or different user entities, or combinations thereof.

Embodiments of user equipment 130 are configured to provide for bidirectional communication with a CP (e.g., using one or more Internet Protocol (IP) communication links), such as to request content, to negotiate content delivery, to perform interactive functionality with respect to content delivery, to report receipt of content and/or other information, and/or the like. Accordingly, such user equipment, as may support unicast and/or broadcast content delivery, can be monitored when they are under coverage of network 110. User equipment provided in a Receive Only Modem (ROM) configuration generally utilize a broadcast feed that is guaranteed to carry service. Such ROM configured user equipment are expected to be largely fixed reception and may be connected by wired or wireless IP (e.g., in the home), although ROM configured user equipment implementing mobile reception, such as automotive ROM configured user equipment, may likewise have IP access (e.g., through the host vehicle systems or other cooperative system). Accordingly, even user equipment provided in such ROM configurations may be monitored (e.g., a URL for reporting back may be provided to the devices).

Network 110 provides communication infrastructure facilitating data communication between CP system 120 and user equipment 130 of the embodiment illustrated in FIG. 1. Network 110 may comprise various configurations of communication networks, such as may provide wireless communications links, wired communication links, optical communication links, and/or combinations thereof. For example, network 110 may comprise a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc. Irrespective of the particular configuration of the network infrastructure facilitating the communication links between CP system 120 and user equipment 130, the network provides a robust network interface to facilitate an understanding of the network by CP system 120 without disclosing configuration details of network 110 to CP system 120. For example, gateway 111 is configured to present a robust network interface, operable to provide CP/network interface 150 in accordance with embodiments herein, to CP system 120.

Gateway 111 may, for example, comprise a processor-based system disposed at the edge of network 110 operable to collect, aggregate, and/or communicate information regarding the area(s) that can be covered and information regarding the nature of the coverage provided, such as may comprise information regarding the currently available and reachable receivers within one or more areas served by network 110, for providing to CP systems (e.g., CP system 120) in communication therewith. It should be appreciated that logic of gateway 111 may provide operation to collect, aggregate, and/or communicate such information. Additionally or alternatively, logic of gateway 111 may operate in cooperation with components external thereto, such as functionality of infrastructure of network 110 (e.g., logic of base stations, routers, switches, etc.), logic of a client application executed by user equipment (e.g., user equipment 130), and/or the like.

As shown in the embodiment of FIG. 1, CP/network interface 150 provided by gateway 111 of embodiments may facilitate communication of content (e.g., information flows 151 and 152) from CP system 120 (e.g., by media servers 121 and 122) to various user equipment (e.g., user equipment 130) in communication with network 110. CP/network interface 150 provided by gateway 111 of embodiments herein additionally or alternatively facilitates communication of robust network information, such as may include service area information and/or coverage nature information, (e.g., information flow 153) from network 110 to CP system 120.

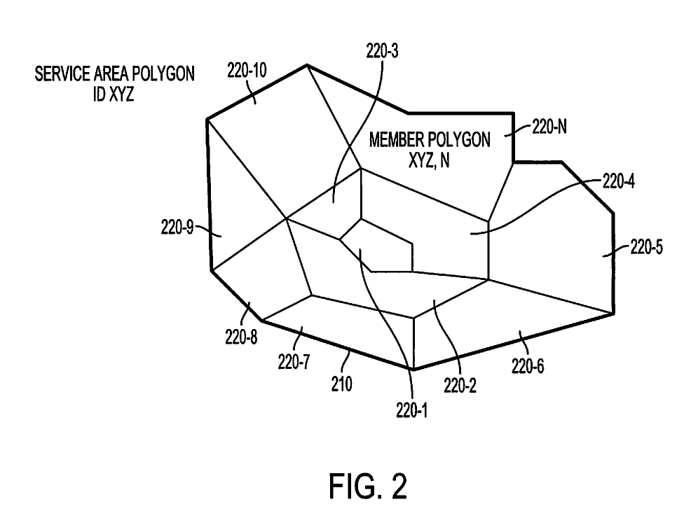

Network information provided via CP/network interface 150 of embodiments of the present disclosure includes service area information providing descriptions of covered areas (e.g., broadcast service area information providing descriptions of areas covered by one or more broadcast services) by means of, for example, a series of polygons. FIG. 2 shows an example of polygons as may be utilized to provide descriptions of covered areas according to some embodiments. In particular, the exemplary embodiment of FIG. 2 provides a covered area (e.g., a portion of a service area of network 110) description comprising service area polygon 210 and member polygons 220-1 through 220-N. The individual member polygons may, for example, be identified by a member polygon ID. Similarly, the service area polygon corresponding to the service area of one or more member polygons may be identified by a service area polygon ID. In the service area information provided via CP/network interface 150 the outline of each of the foregoing polygons may be described by a series of points, such as may be defined by latitude and longitude pairs. The description of an individual member polygon may, for example, be provided as an XML document or portion thereof, such as may include the member polygon coverage area and member polygon ID. The description of a service area polygon (i.e., the outer boundary of a service area comprising one or more member polygons) may be provided as an XML document or portion thereof, such as may include a list of the member polygons (and possibly the member polygon coverage areas) and service area polygon ID.

Each of the member polygons of embodiments has a set of attributes that may be provided to the CP system in association with the polygon descriptions. For example, network information of a CP/network interface herein may include coverage nature information providing coverage grade attributes for member polygons. The coverage grade attribute of embodiments describes, in general terms, device type pairs in terms of reception condition and device types. As a specific example, the coverage grade attributes may specify the percentage coverage area of a particular coverage type (e.g., indoor suburban/mobile, outdoor suburban/mobile, indoor suburban/fixed, indoor rural/fixed, outdoor rural/mobile, roof top/fixed, roof top/automotive, indoor urban/mobile, etc.) at a specific service grade (e.g., average bit rate, minimum/maximum bit rate, etc.).

Attributes of coverage nature information provided to the CP in association with the polygon descriptions of service area information of embodiments may additionally or alternatively include service population characteristic information. Service population characteristic information of embodiments includes attributes such as the number of known devices present in a polygon by device type pair, the number of devices active on a specific service by device type pair, demographic membership (e.g., according to CP definition) by device type pair, and/or known or predicted user behavior (e.g., from user profile, viewing or purchasing history, etc.) associated with active devices on specific service.

Gateway 111 may operate to provide communication of the above described network information (e.g., information flow 153) from network 110 to CP system 120 in response to a specific request from CP system 120. For example, it is likely that a query for such information by CP system 120 is related to an event (e.g., initiation of a content delivery service, an ad avail opportunity, an ad sale, etc.), and thus a CP system request to the network may be advantageous in providing an “at this moment” aspect of the service area information and/or coverage nature information provided via CP/network interface 150 of embodiments. Additionally or alternatively, gateway 111 may provide such information to CP system 120 periodically (e.g., in increments of so many minutes, such as every 5 or 10 minutes, for example).

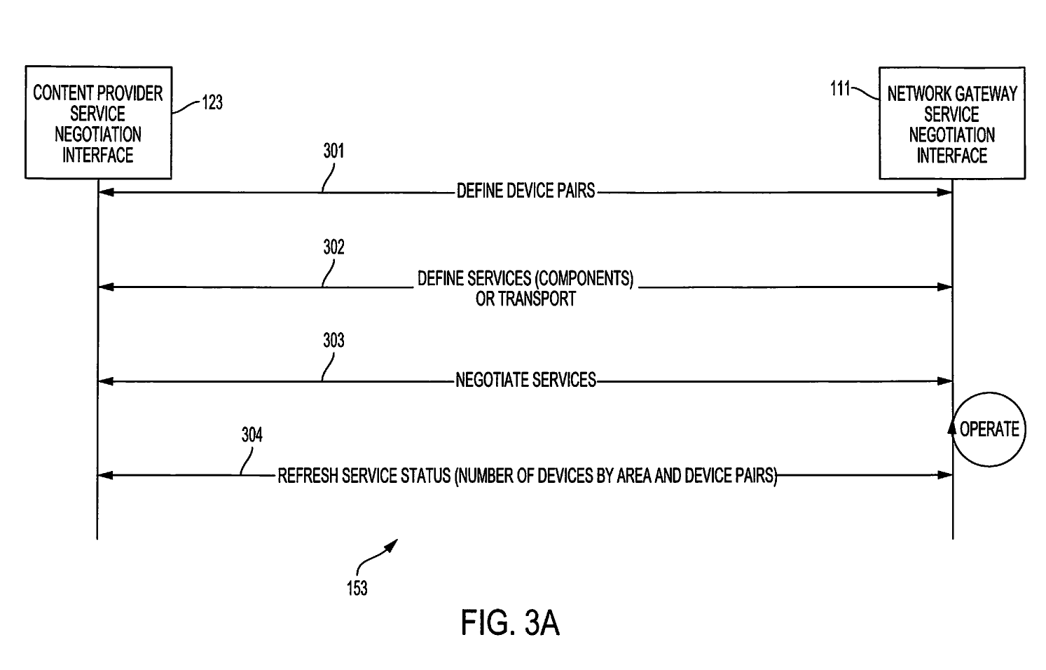

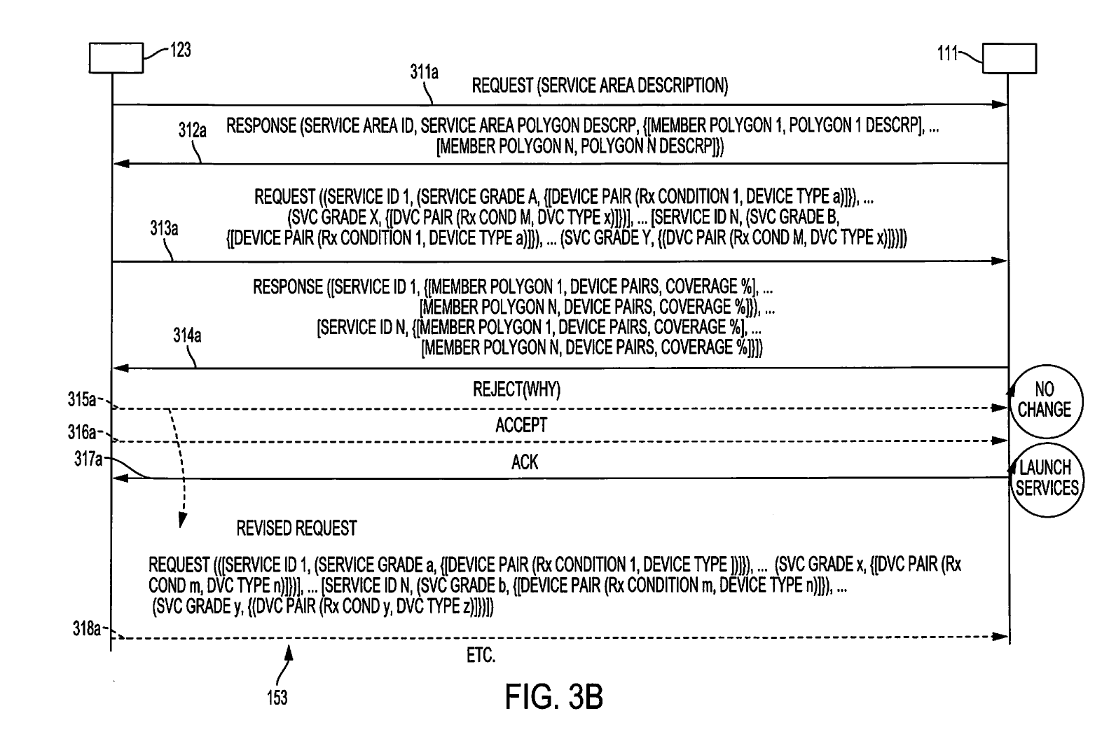

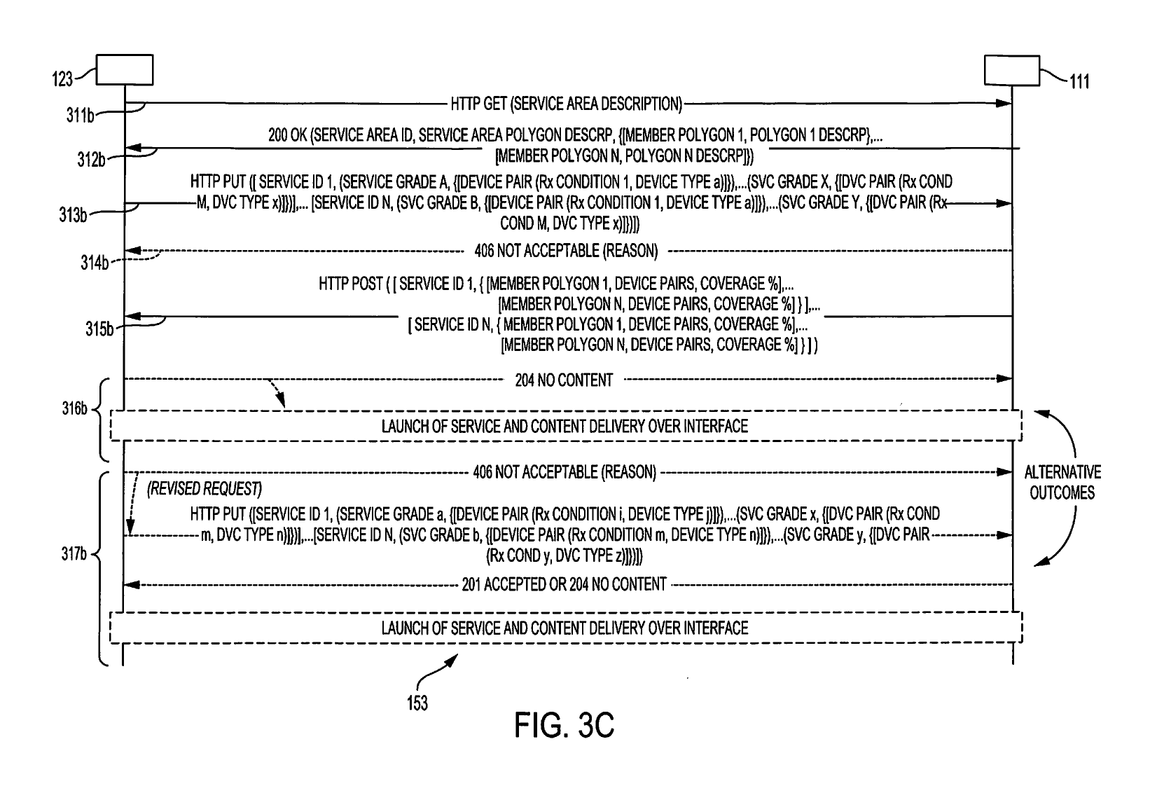

Exemplary schemas for operation of CP system 120 using a CP/network interface according to concepts of the present disclosure are shown in FIGS. 3A-3C. The exemplary schema of FIG. 3A illustrates a high level service transaction utilizing CP/network interface 150 of embodiments herein wherein the illustrated data exchanges between CP system 120 and gateway 111 of network 110 facilitate an understanding of the network by CP system 120 enabling service negotiation and operation without systems of network 110 disclosing network configuration details to CP system 120. In particular, operation implemented according to the exemplary schema illustrated in FIG. 3A provides for CP system 120 defining attributes used with respect to the service to be provided (e.g., device type pairs, services, service components, transport, etc.) and negotiating services to be delivered by the network (e.g., using the defined attributes). The exemplary schemas illustrated in FIGS. 3B and 3C provide additional detail with respect to data flows of the illustrative high level service transaction of FIG. 3A. Operation implemented according to the exemplary schemas illustrated in FIGS. 3B and 3C provide for CP system 120 obtaining network information (e.g., including the aforementioned service area information and coverage nature information) with respect to the areas in which services (e.g., defined using the aforementioned attributes) can be delivered and negotiation for providing the services in accordance with embodiments of the disclosure. In particular, FIG. 3B shows a logical message flow of the interactions between the CP system and network, whereas FIG. 3C shows an implementation via a RESTful API (e.g., a ServiceRequest and/or AdAvail RESTful API for gateway 111) whose resources are invoked by HTTP methods. The data exchanges of FIGS. 3A-3C may, for example, be implemented as part of data flow 153 (FIG. 1).

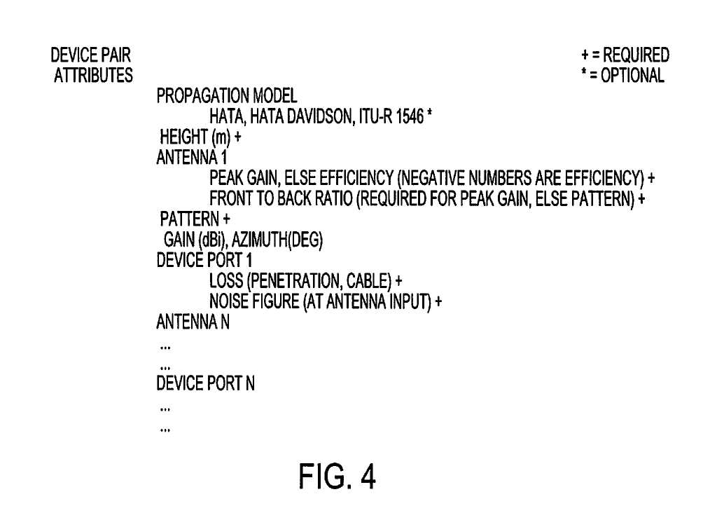

FIG. 3A illustrates example data exchanges between service and ad management logic 123 of CP system 120 and gateway 111 of network 110 providing operation to deliver services in network 110 according to embodiments herein. The service transaction operation illustrated in FIG. 3A begins with ad management logic 123 of CP system 120 establishing a definition of one or more device type pairs for use in describing aspects of network 110 without knowledge of the exact or detailed network configuration and without information regarding particulars of the users identities or user equipment of the network (data exchange 301). For example, receivers (e.g., user equipment 130) may be broken down for classification according to embodiments of the disclosure into reception condition (e.g., antenna and position, there generally being one defined antenna per active port) and device type (e.g., equipment configuration). As a specific example, a device type pair may be described as “roof top directional” (e.g., as may be known or assumed to provide at least 10 dBd gain, 16 dB front to back ratio antenna, and 10 m height) and a “fixed receiver” (e.g., as may be defined by an effective noise figure and number of available ports). Accordingly, device type pairs of embodiments comprise a collection of attributes for each of the reception condition and device type. The description of an device type pair may, for example, be provided as an XML document or portion thereof, such as may include various attributes regarding the device type pair. FIG. 4 shows an exemplary device type pair description document, including propagation model attributes, antenna attributes, and device port attributes, as may be utilized according to embodiments of the disclosure.

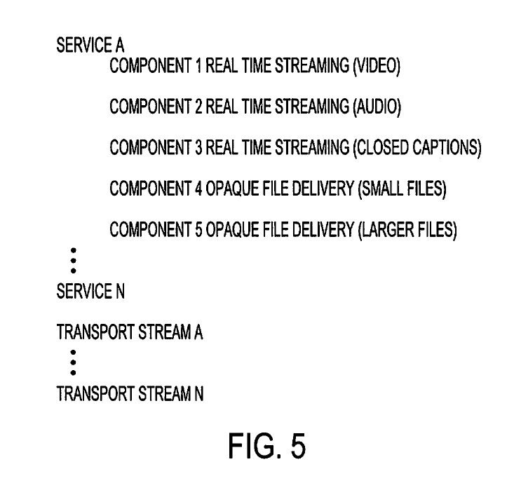

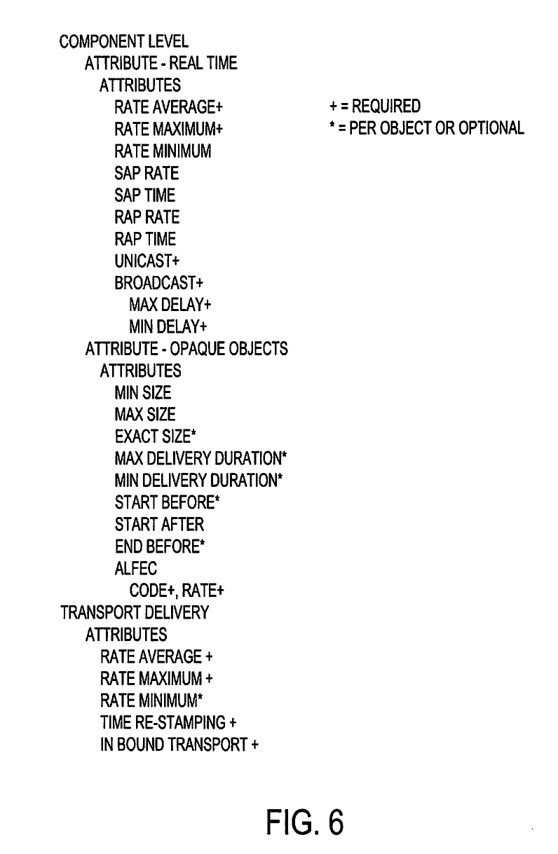

The service transaction operation illustrated in FIG. 3A further includes ad management logic 123 of CP system 120 establishing a definition of one or more services and/or transport for use in negotiating and providing services according to concepts herein (data exchange 302). For example, a service may be defined by a collection of service components (e.g., Service A of FIG. 5 defined by Components 1-5), wherein one or more service components might not be delivered for all combinations of reception conditions and device types (e.g., Components 1-3 of Service A may be delivered for a first combination of reception condition and device type, Components 2, 3, and 5 of Service A may be delivered for a second combination of reception condition and device type, and Components 4 and 5 of Service A may be delivered for a third combination of reception condition and device type) and some components may require the reception of another component (e.g., use of Component 3 of Service A may require receipt of Component 2). The components of a service of embodiments of the present disclosure may comprise streaming delivery components (e.g., Components 1-3 of FIG. 5 shown as RT components) and/or opaque delivery components (e.g., Components 4-6 of FIG. 5 shown as opaque file delivery components). Accordingly, a service may be defined in terms of its service components, wherein the description of such service components may, for example be provided as an XML document or portion thereof, such as may include various attributes regarding the service components. FIG. 6 shows an exemplary component level description document, including RT component attributes and opaque component attributes.

The service transaction operation illustrated in FIG. 3A further includes ad management logic 123 of CP system 120 negotiate with network 110 to establish a service, such as to provide a streaming content delivery service to one or more instances of user equipment (e.g., user equipment 130) operating within the coverage of network 110 (data exchange 303). Detail with respect to exemplary schemas for service negotiation according to embodiments are described in further detail below with reference to FIGS. 3B and 3C.

Irrespective of the particular data flows utilized an a service negotiation, successful service negotiation results in operation of CP system 120 providing one or more services to one or more instances of user equipment operating within the coverage of network 110 (e.g., as represented by the operate loop of FIG. 3A). In operation according to embodiments, service status information may be refreshed (data flow 304), such as to provide current network information (e.g., number of devices by area, device type pairs, etc.) to CP system 120. CP system 120 of embodiments may utilize this refreshed information in negotiating and providing services, in providing ad avail opportunity descriptions provided by embodiments herein, etc.

FIGS. 3B and 3C illustrate example data exchanges between service and ad management logic 123 of CP system 120 and gateway 111 of network 110 in which the CP system 120 is operable to negotiate with network 110 to establish a service (e.g., a streaming content delivery service to one or more instances of user equipment, such as user equipment 130, operating within the coverage of network 110). The data exchange of FIG. 3B illustrates a general architecture for service negotiation in which robust network data is provided to the CP system, whereas the data exchange of FIG. 3C illustrates an architecture for service negotiation in which robust network data is provided to the CP system based on the RESTful architecture and conducted via HTTP transactions. The limits of the negotiation may, for example, be constrained by an SLA, which may be enforced on the CP/network interface of embodiments herein.

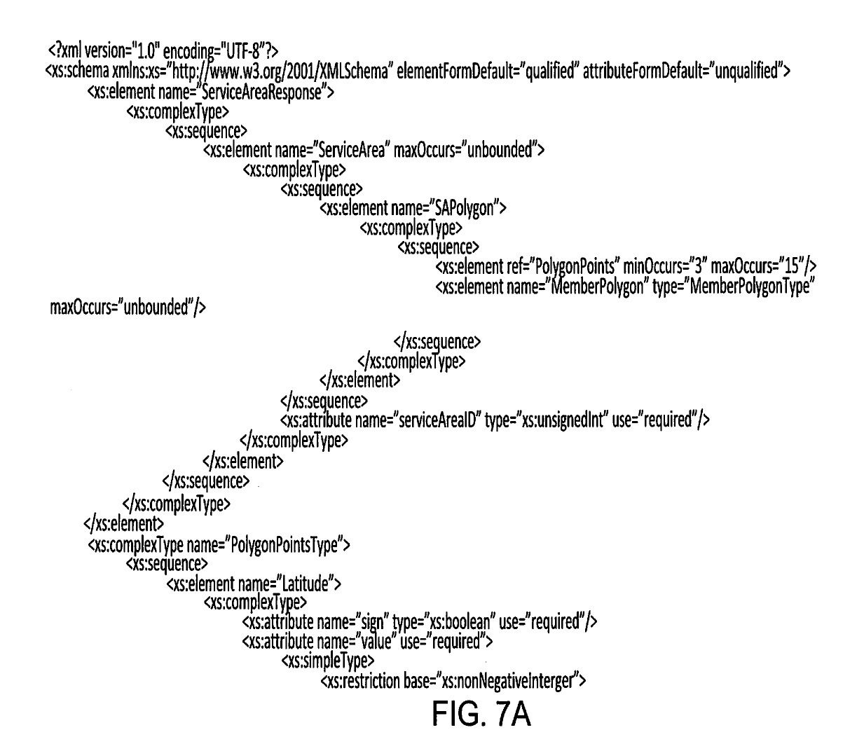

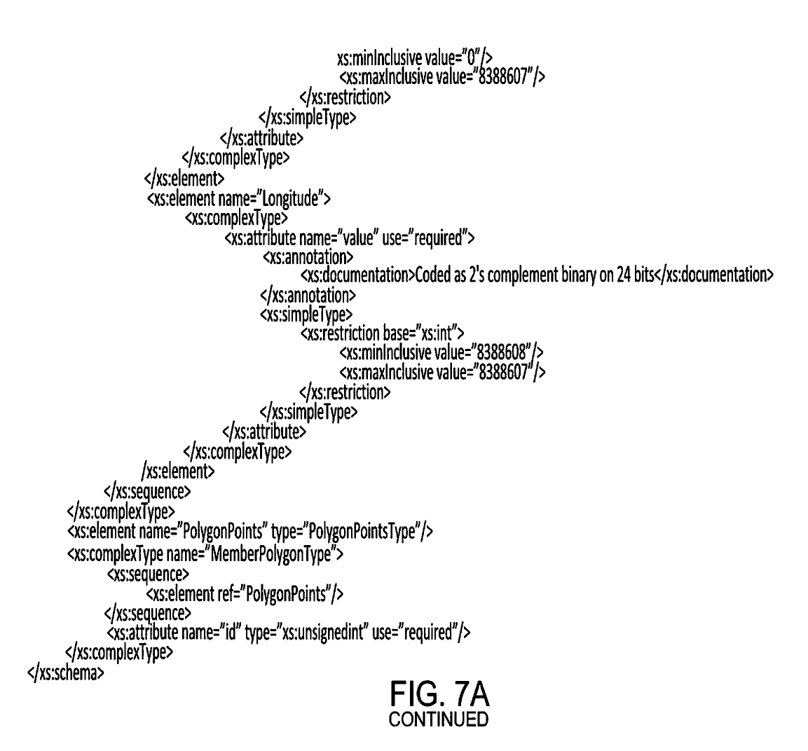

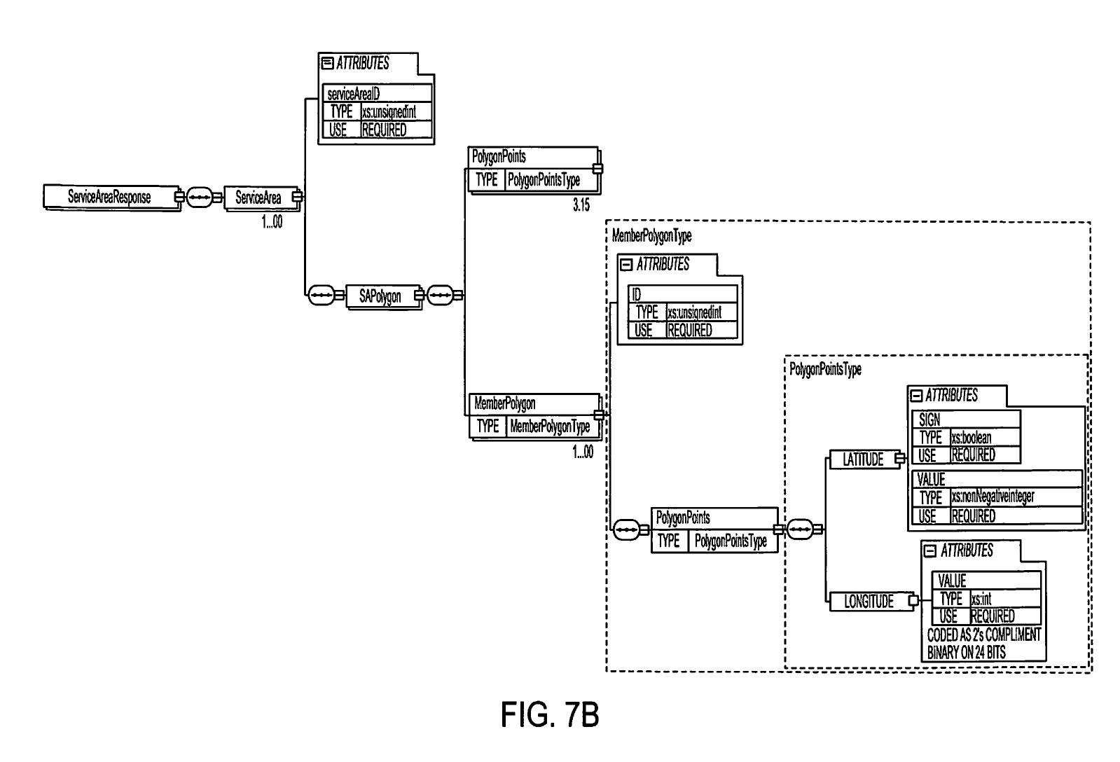

The service negotiation data exchanges of the exemplary data flows of both FIGS. 3B and 3C begin with CP system 120 initiating a request for a service area description (data exchanges 311a and 311b). In response, network 110 provides a service area response, such as may comprise the above described service area information and/or coverage nature information, to CP system 120 (data exchanges 312a and 312b). The network information obtained by CP system 120 may be provided in one or more XML document (e.g., comprising service area information, coverage nature information, and/or service population characteristic information, such as in the form of the above described service area polygon coverage area information, member polygon coverage area information, and/or member polygon attribute information) of data flow 153 to CP system 120. Exemplary XML schema depictions of a service area response message as may be provided according to embodiments are shown in the textual representation of FIG. 7A and the graphical representation of FIG. 7B. It should be appreciated that the normative description of a polygon for representing the service area in the exemplary embodiments is in accordance to the definition of polygon in 3GPP TS 23.032 (Universal Geographical Area Description (GAD)).

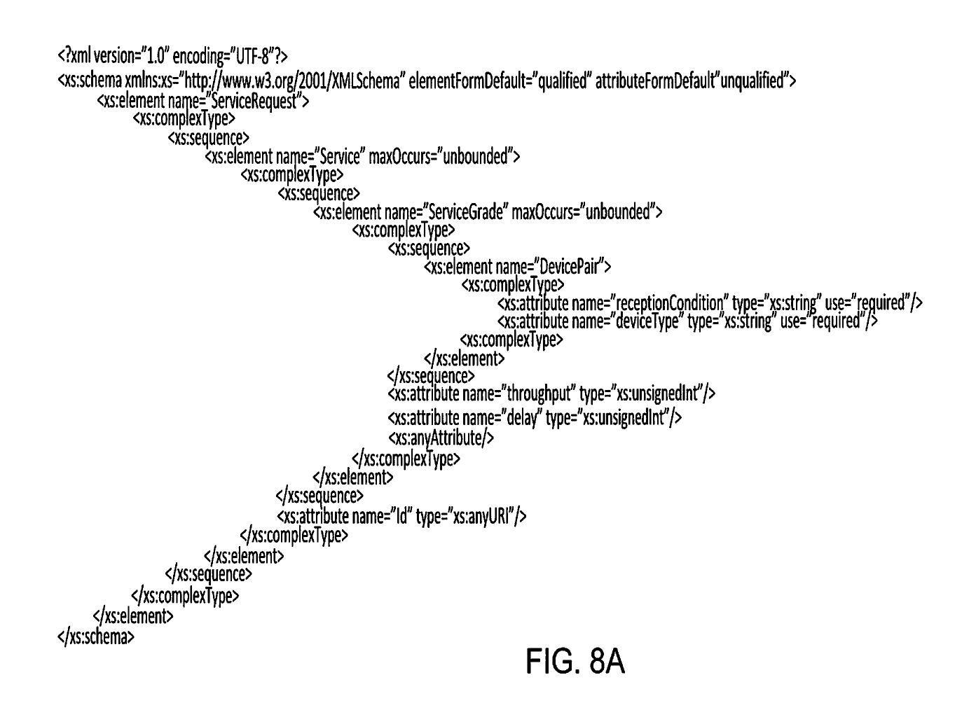

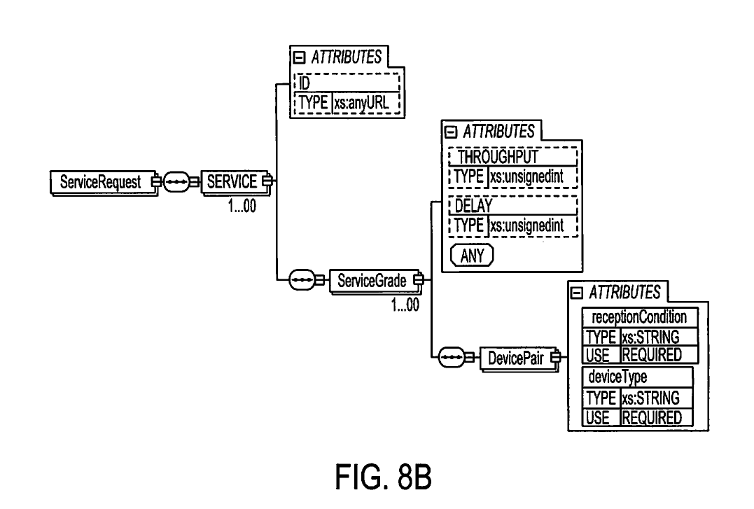

The service negotiation data exchanges of the exemplary data flows of both FIGS. 3B and 3C provide a service request from CP system 120 to network 110 (data exchanges 313a and 313b) in which the CP system specifies one or more attributes with respect to the service to be provided. In operation according to embodiments of the present disclosure, the service request message of embodiments may include, for each service, the corresponding service grade objective (e.g., comprising metrics such as average throughput, maximum bit rate, transmission delay through the network, maximum delay, etc., and may differ by the content components of the service), the targeted device type pair information (e.g., comprising one or more pairings of reception condition information, such as rooftop, mobile, indoor, etc., and device type, such as fixed, automotive-installed, mobile, etc.). For example, the CP system may provide a description of a service which contain a number of service components in the service request. The definition of service for a given device type pair may, for example, comprise a subset of the all the service components in the service, and the CP system may provide a description of each service according to included service components and service grade per service component. However, in operation according to embodiments, a single service grade maybe applicable to all service components. For example, if service grade information is not signaled per service component in the service request then all service components may be included in the one service grade. CP system 120 (e.g., through operation of service and ad management logic 123) of embodiments may utilize the network information provided in the service area response message to determine one or more attributes of the service to be provided, such as the service grade, the user equipment and/or member areas to be provided the service, etc., wherein one or more determined attributes may be included in the service request. It can be appreciated from the example of FIG. 3C, providing an implementation using the RESTful architecture style and HTTP interactions between network 110 and CP system 120, a service request may be sent as an HTTP PUT request message, with various attributes (e.g., the service ID(s), service grade, device type pair information, etc.) carried in the body of the request message. Exemplary XML schema depictions of a service request message as may be provided according to embodiments are shown in the textual representation of FIG. 8A and the graphical representation of FIG. 8B.

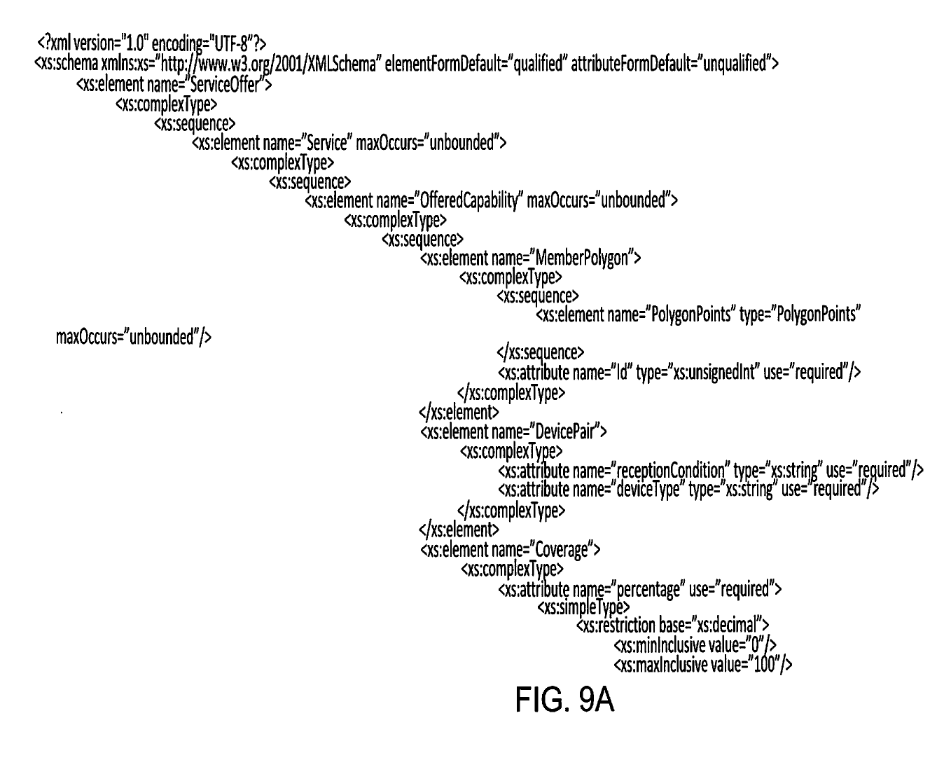

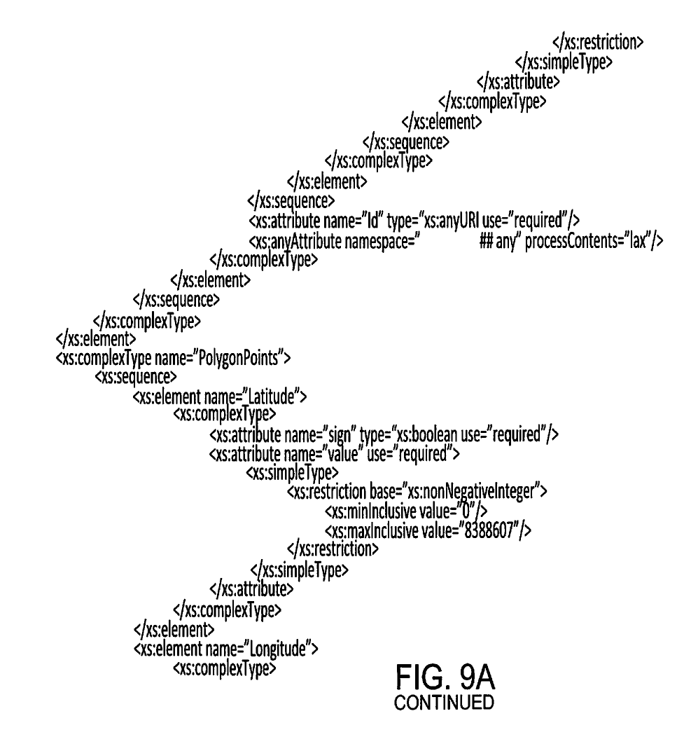

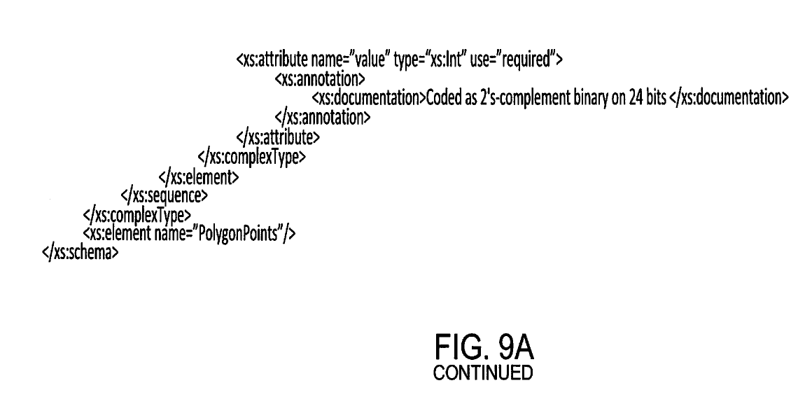

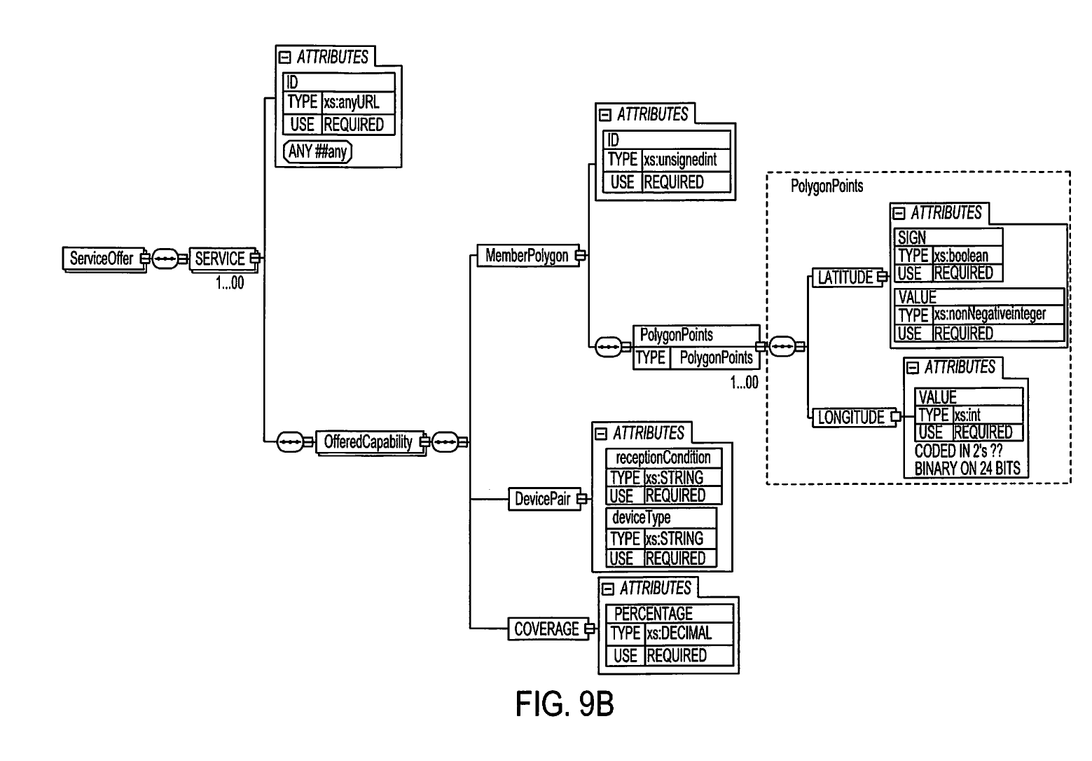

In operation according to the service negotiation data exchanges of the exemplary data flows of both FIGS. 3B and 3C, a service offer message (data exchanges 314a and 315b) may be provided to CP system 120 by network 110 in response to the service request message. A service offer message may, for example, contain the offered (i.e., supportable) capabilities by the network for the previously requested service from the CP system. For each service, the service offer message of embodiments may provide information such as the available service reception area as defined by a member polygon, the corresponding device type pair information for the available service reception, the percentage coverage area within the polygon which meets the desired service grade for that service, etc. It can be appreciated from the example of FIG. 3C, providing an implementation using the RESTful architecture style and HTTP interactions between network 110 and CP system 120, a service offer message may be sent as an HTTP POST request message, with various attributes (e.g., service ID(s) and associated capability offering information) carried in the body of the request message. Exemplary XML schema depictions of a service offer message as may be provided according to embodiments are shown in the textual representation of FIG. 9A and the graphical representation of FIG. 9B.

It should be appreciated that the network may or may not be able to meet the particulars of the service request made by the CP system, such as may be communicated by the network to the CP system using the foregoing service offer message (e.g., data exchanges 313a and 313b) and/or via separate data exchanges (e.g., data exchange 317a to indicate the ability to meet the service request and data exchange 314b to indicate the inability to meet the service request). Where the network is able to meet the particulars of the service request, the service offer may provide information consistent with that of the service request message issued by the CP system, such as to confirm that the various attributes of the service request that will be met, wherein the service offer may be accepted by the CP system (e.g., data exchange 316a) and/or the service initiated (e.g., implementing service launch operation of data exchange, such as that of 315b of FIG. 3C, and/or initiation of content delivery by the CP system, such as via one or more of data flows 151 and 152). However, where the network is able to meet the particulars of the service request, embodiments may operate to omit providing a service offer message (e.g., to reduce bandwidth utilized by data flow 153), such as to instead proceed to launching the service (e.g., providing the acknowledgment message of data exchange 317a of FIG. 3B followed by content delivery by the CP system via one or more of data flows 151 and 152 or by providing the service launch operation of data exchange 315b of FIG. 3C followed by content delivery by the CP system via one or more of data flows 151 and 152).

However, where the network is unable to meet the particulars of the service request, this inability may be communicated by the network to the CP system in various ways. For example, one or more service components might not be deliverable for all combinations of reception condition and device types (e.g., a personal mobile device may take a maximum of standard definition video as compared to high definition to fixed roof top receivers). Accordingly, an indication that the service request or some portion thereof is not acceptable to the network, possibly including information regarding a reason for the unacceptability, may be provided to the CP system (e.g., data exchange 314b). Additionally or alternatively, the inability to meet the particulars of the service request may be communicated using a service offer (e.g., data exchanges 313a and 313b) of embodiments herein. For example, the service offer may provide information that is inconsistent with that of the service request message issued by the CP system. Accordingly, a service offer of embodiments herein may comprise information regarding attributes with respect to the service that the network is able to support, wherein one or more of the attributes may differ from one or more corresponding attributes of the service request. In operation according to embodiments of the disclosure, CP system 120 (e.g., through operation of service and ad management logic 123) may utilize information provided in the service offer message to determine if a suitable service may nevertheless be initiated. If it is determined that a suitable service is not available to be initiated, the service offer may be rejected by the CP system (e.g., data exchange 315a). However, if it is determined that a suitable service is available to be initiated, the CP system of embodiments may initiate a revised service request consistent with the service offer may be provided (e.g., data exchanges 318a and 317b), whereby the service may be initiated (e.g., implementing service launch operation of data exchange, such as that of 315b of FIG. 3C, and/or initiation of content delivery by the CP system, such as via one or more of data flows 151 and 152).

It should be appreciated that the data format of service request messages of embodiments herein may be the same as between the service request message provided in the initial request of data exchanges 313a and 313b and the service request message provided in the subsequent request of data exchanges 318a and 317b. That is, the CP system of the embodiments illustrated in FIGS. 3B and 3C is requesting the same properties for the delivery of its services over the network, with the difference between the two requests being the initial request represents the service request message prior to knowing what the network can support, and the subsequent request represents a the service request consistent with the available capabilities indicated by the network.

It should be appreciated that the network information obtained using CP/network interface 150 of embodiments may be utilized by CP system 120 for a number of purposes in addition to or in the alternative to the exemplary service negotiations described above. For example, a CP may utilize a CP/network interface of embodiments herein to obtain information useful in providing one or more service, providing information regarding a service, providing information regarding an opportunity available in association with a service, etc. As a specific example, CP system 120 may initiate a request for a service area description (e.g., using a data exchange similar to data exchanges 311a and 311b) to obtain network information via CP/network interface 150 (e.g., using a data exchange similar to data exchanges 312a and 312b) for use with respect to a linear service opportunity (e.g., with respect to an ad avail). In particular, a CP system of embodiments herein may utilize data from network information to provide a description of the linear service opportunity, such as to offer particular ad avail opportunities to other entities (e.g., NO, external customer, etc.).

An ad avail opportunity may be represented, for example, as service replacement for a period of time (e.g., a traditional ad slot in live or linear streaming content), an opportunity for a banner or other overlay, etc. Ad avail opportunities may be addressable, such as to reach only a specific set of user equipment, or locations or combinations of both.

In operation according to embodiments, the CP system has knowledge of the numbers and potential times of ad avails (i.e., linear service opportunities in the form of advertising spots available in association with some content), as well as information regarding the scope of the ad avail opportunities (e.g., opportunity to insert an ad into the content, opportunity to overlay an ad on or in association with the content, etc.). Accordingly, the CP system of embodiments may use the foregoing knowledge in combination with the foregoing network information (e.g., service area information and coverage nature information, and particularly service population characteristics information) to provide robust ad avail description document (e.g., as may be communicated to the NO and/or other entities via data flow 153 of CP/network interface 150) providing information regarding the ad avail opportunity and the audience.

Using ad avail description documents of embodiments of the present disclosure, a CP may offer ad avails to the NO, to an external customer, and/or the like, wherein these potential consumers of the ad avails are provided robust information regarding the ad avail opportunity and audience to facilitate determining the value of the ad avail to their particular promotional or other needs, to target ads appropriately, etc. Accordingly, in operation according to embodiments, an ad avail description document provides information regarding specific attributes of an ad avail opportunity that allow the NO or other entity (e.g., third party advertising placement reseller or agency) to make determinations regarding purchasing/reselling an ad avail, whether to fill the ad avail with generic or targeted ads, the particular ad content to fill the ad avail, etc. Moreover, not only may the CP utilize ad avail description documents of embodiments herein to offer ad avails to other parties, such as the NO or third parties, so too may the NO utilize ad avail description documents to offer ad avails to an external customer, such as over an interface similar to that of the CP/network interface described above.

In operation according to embodiments, CP system 120 may have an inventory of ad avails, associated with its services and programs for delivery over network 110, that may be filled by the CP system or that may be offered (e.g., through a description provided by an ad avail description document communicated via CP/network interface 150) to the NO or an external party for purchase. Ad avail information of embodiments may, for example, be provided in association with streaming content using linking methods such as Xlink and/or inline insertion methods such as SCTE 35. Basic structures for description of geographical areas and their attributes may be replicated across CP/network interface(s). In some instances the geographical area may be implicit, such as where the geographical area for the ad avail opportunity is same as the known service area of the gateway the CP system connects to.

Ad avail information for general distribution ads (e.g., those ads which go to entire service area(s) with a certain service ID) may be inserted in the content streams provided to the network by the CP system (e.g., the media stream may include a conventional instruction to deliver this media (service ID) to these service areas). The ad avail information for these general distribution ads may be marked as optional, such as to allow the NO (e.g., through operation of ad control logic disposed in the network) to replace the ad for some consideration (e.g. money or other ad avails). For example, saleable ad avails may be recognized via agreed string match in the applicable Xlink, whereby ad control logic of the network may replace the Xlink provided by the CP system with an Xlink that will resolve to the network's ad. For DASH or similar adaptive HTTP streaming format such as CMAF or HLS, an Initialization Segment (IS) or similar may be utilized unless the ad conforms to the stream IS in which it is inserted. For ad displays which are overlaid on existing video the area of the overlay can be described via conventional text overlay methods, such as closed caption or timed text.

The CP may additionally or alternatively choose to deliver an ad (e.g., targeted ad) to a specific demographic or other collection of attributes (e.g., one or more attributes of the coverage nature information) within a service area or portion thereof (e.g., one or more member polygons of the service area information). For example, the CP system may deliver a description of such a targeted ad as a URL or URI, for example, pointing to a replacement period and a playback time or a specific target period, such as may be signaled via SCTE 35 or other inline insertion method syntax as a table or an XML document. A description of the target(s) (e.g., user equipment, service area portion, device type pairs, etc.) may be provided in the foregoing description (e.g., as an XML description of target member polygon, demographic attributes, and device type pair, as may have been determined from the network information obtained via the CP/network interface). It should be appreciated that the network may accept or reject a request for delivery of such target ads under current or future service conditions, if different than the current service conditions are known via schedule.

When making an ad avail opportunity (e.g., an ad avail opportunity for an ad targeted to a specific demographic or other collection of attributes within a service area or portion thereof) available to the network or external party, the CP system may describe the ad avail opportunity externally in terms that mirror or are similar to the network description (e.g., using an ad avail description document of embodiments herein) on a CP/network interface implemented in accordance with concepts herein. Additionally or alternatively, the NO may offer an ad avail opportunity to external parties using an ad avail description document on a similar network interface. For example, the CP system may deliver a description of an ad avail opportunity as a URL, for example, pointing to an ad avail description document that includes a description of the target(s) (e.g., user equipment, service area portion, device type pairs, etc.), such as may be signaled via SCTE 35 or other inline insertion method syntax as a table or an XML document. Accordingly, embodiments operate to repurpose messaging used to signal ad insertion to instead provide information that allows a buyer/reseller of ads (e.g., the NO, an external party, etc.) to not only identify the ad avail opportunity but to also be provided with information from which to make an informed ad buying decision and/or to enable targeted ad delivery. It should be appreciated that the sale of ads for the ad avail opportunities described (e.g., using ad avail description documents) according to embodiments of the disclosure may be performed using various existing ad sales platforms, such as those of Google Inc. and Amazon.com, Inc.

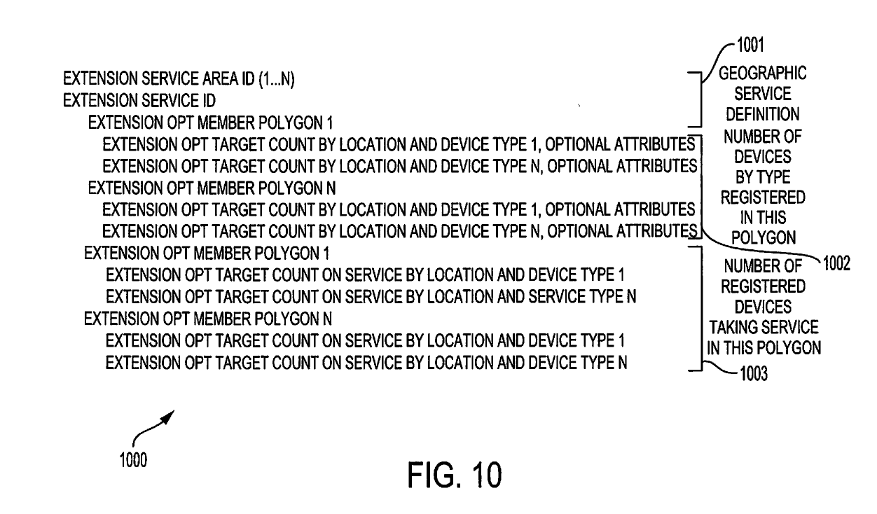

FIG. 10 shows an exemplary configuration of an ad avail description document according to embodiments of the present disclosure. Ad avail description document 1000 illustrated in FIG. 10 comprises a SCTE 35 XML based ad avail description with unique ID, although other architectures may be utilized in providing ad avail description documents of embodiments. An ad avail description document may include various service area information and coverage nature information. For example, the illustrated embodiment of ad avail description document 1000 includes geographic service definition information (portion 1001), information regarding the number of devices by type registered in the member polygon (portion 1002), and information regarding the number of registered devices taking service in the member polygon (portion 1003). It should be appreciated that ad avail description document of embodiments may be provided as a single file (e.g., single XML file) or a multiple files (e.g., one or more of the aforementioned portions split with extensions in a separate XML file identified ad unique ID).

The content for the ads to be inserted with respect to an ad avail may reside in various places within and/or external to the network. For example, ad content may be identified with Ad ID information, as provided by Advertising Digital Identification, LLC, or EIDR information, as provided by the Entertainment ID Registry Association. The construction of an ad content file location URL may contain either ADID or EIDR in a systematic manner. The to-be inserted ad content may be fetched (e.g., the ad content file location may be understood via URL) on demand via unicast, cached on the device via broadcast or unicast, etc., such as in accordance with the capability of the network infrastructure. Accordingly, ad content utilized according to embodiments may reside in the general Internet, on a CP system (e.g., one or more servers 124), on a network server (e.g., one or more servers 112). A general Internet server may provide the best location for serving ad content for ad avail opportunities that are purchased by an external entity (e.g., using an ad avail description document of embodiments). The ad content to be delivered by the CP may be best served from the CP system (e.g., server 124). A network ad server (e.g., server 112) may be the best source for ad content inserted by the network (e.g., for general distribution ads marked as optional and/or for ad avail opportunities that are purchased by the NO using an ad avail description document of embodiments). It should be appreciated, however, that in all cases a third party may be supplying services for any entity, if desired. Irrespective of from where the ad content is provided, embodiments operate to facilitate confirmation of the ad insertion (e.g., providing information regarding the ad insertion to a server under the control of the entity that sold the ad or that is under contract with selling entity). For example, IP capable user equipment or user equipment otherwise having data connectivity and capable of reporting an ad may include a client application for reporting receiving and/or playback of ads, ad servers delivering ad content may report serving ads, etc.

As can be readily appreciated from the foregoing disclosure, embodiments of a CP/network interface herein facilitate negotiation of services over a network and allow the CP system to understand the connected or potentially connected device population, the on service population by device type pair (i.e., reception condition and device type), and the reception geographic locations by geographic polygon(s). Accordingly, a CP/network interface of embodiments facilitates an understanding of the service area for defined services by a CP system. In operation according to embodiments, devices that can connect via wired unicast IP or a wireless (e.g., WiFi) connection to wired IP may be counted as potentially available for personalized ad insertion, whereas non-IP capable devices may be of less interest for targeted ads (e.g., because they cannot report that an inserted ad was viewed or inserted). Using an ad avail description document facilitated by a CP/network interface of embodiments herein, the NO and/or external parties may′ know the existence of an available ad avail opportunity.

The schematic flows of FIGS. 3A-3C are generally set forth as a logical flow diagram. As such, the depicted order and labeled exchanges are indicative of exemplary embodiments of the disclosed methods. Other exchanges, steps, and methods may be conceived that are equivalent in function, logic, or effect to one or more exchanges, steps, or portions of the illustrated methods. Additionally, the format and symbols employed are provided to explain the methods and are understood not to limit the scope of the methods. Although various arrow types and line types may be employed in the flow diagrams, they are understood not to limit the scope of the corresponding methods. Indeed, some arrows or other connectors may be used to indicate only the logical flow of the methods. For instance, an arrow may indicate a waiting or monitoring period of unspecified duration between enumerated steps of the depicted methods. Additionally, the order in which a particular method occurs may or may not strictly adhere to the order of the corresponding steps shown.

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer-readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some embodiments different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Those of skill would further appreciate that the various illustrative logical blocks, modules, circuits, and algorithm steps described in connection with the disclosure herein may be implemented as electronic hardware, computer software stored on a computing device and executed by one or more processing devices, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium may be coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

Although the present disclosure and advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for interfacing a content provider system with a broadcast network, the method comprising:
coupling the content provider system to a gateway interface configured to enable the content provider system to request broadcast service area information of the broadcast network and to provide network information including the broadcast service area information to the content provider system facilitating an understanding of the broadcast network by the content provider system without disclosing configuration details of the broadcast network to the content provider system; and
providing, by the gateway interface in response to a request for the broadcast service area information from the content provider system, a broadcast service area response message comprising at least a portion of the network information to the content provider system, wherein the at least a portion of the network information includes the broadcast service area information.

2. The method of claim 1, wherein the broadcast service area information data regarding one or more geographic areas covered by the broadcast network including a broadcast service area polygon and a plurality of member polygons, wherein the broadcast service area polygon describes a series of points defining an outer geographic boundary of a broadcast service area encompassing the plurality of member polygons, and wherein each member polygon of the plurality of polygons describes a series of points defining an outer geographic boundary of a portion of the broadcast service area having particular demographic attributes and reception condition and device type pairings.

3. The method of claim 1, wherein the at least a portion of the network information includes data regarding network coverage provided within the broadcast service area including a percentage coverage at a specific service grade for supported services within the broadcast service area.

4. The method of claim 1, wherein the at least a portion of the network information includes data regarding network coverage provided within the broadcast service area including data regarding currently reachable receivers in the broadcast service area.

5. The method of claim 4, wherein the data regarding currently reachable receivers in the broadcast service area comprises numbers and types of the currently reachable receivers in the broadcast service area.

6. The method of claim 5, wherein the data regarding network coverage provided within the broadcast service area comprises numbers and types of potentially reachable receivers in the broadcast service area, wherein the potentially reachable receivers are present on a specific service although not currently engaging in reporting connectivity.

7. The method of claim 1, wherein the at least a portion of the network information includes data regarding network coverage provided within the broadcast service area including data regarding demographics for users in the broadcast service area.

8. The method of claim 1, wherein the request from the content provider for the broadcast service area information and the providing the broadcast service area response message by the gateway including the broadcast service area information invoke a RESTful API for the gateway interface on resources and associated properties managed by a network operator of the broadcast network, wherein the RESTful API implements HTTP methods and corresponding HTTP responses.

9. The method of claim 1, further comprising:
conducting a service negotiation data exchange to initiate one or more services in the broadcast network by the content provider system, wherein the request for the broadcast service area information and the broadcast service area response message are part of the service negotiation data exchange.

10. The method of claim 1, further comprising:
receiving, by the gateway interface, a service request message provided by the content provider system, wherein the service request message specifies one or more attributes with respect to a service to be provided, and wherein at least a portion of the one or more attributes are based upon the at least a portion of the network information provided in the broadcast service area response message.

11. The method of claim 10, further comprising:
providing, by the gateway interface, a service offer message to the content provider system, wherein the service offer message comprises information regarding attributes with respect to a service that the broadcast network is able to support, wherein one or more of the attributes of the service offer message differ from one or more corresponding attributes of the service request message; and
receiving, by the gateway interface, a revised service request message provided by the content provider system, wherein the revised service request message specifies one or more attributes with respect to a service to be provided, and wherein at least a portion of the one or more attributes are based upon the information regarding attributes with respect to the service that the broadcast network is able to support provided in the service offer message.

12. The method of claim 11, wherein the service request message, the service offer message, the revised service request message, and responses to each of the service request message, service offer message, and revised service request message are provided using HTTP methods in accordance with defined operations on a RESTful API of the gateway interface.

13. An apparatus configured for interfacing a content provider system with a broadcast network, the apparatus comprising:
means for coupling the content provider system to a gateway interface configured to enable the content provider system to request broadcast service area information and to provide network information including the broadcast service area information to the content provider system facilitating an understanding of the broadcast network by the content provider system without disclosing configuration details of the broadcast network to the content provider system; and
means for providing, by the gateway interface in response to a request for the broadcast service area information from the content provider system, a broadcast service area response message comprising at least a portion of the network information to the content provider system, wherein the at least a portion of the network information includes the broadcast service area information.

14. The apparatus of claim 13, further comprising:
means for conducting a service negotiation data exchange to initiate one or more service in the broadcast network by the content provider system, wherein the request for the broadcast service area information and the broadcast service area response message are part of the service negotiation data exchange.

15. The apparatus of claim 13, further comprising:
means for receiving, by the gateway interface, a service request message provided by the content provider system, wherein the service request message specifies one or more attributes with respect to a service to be provided, and wherein at least a portion of the one or more attributes are based upon the at least a portion of the network information provided in the broadcast service area response message.

16. A non-transitory computer-readable medium having program code recorded thereon for interfacing a content provider system with a broadcast network, the program code comprising:
program code executable by a computer for causing the computer to:
interface the content provider system to a gateway configured to enable the content provider system to request broadcast service area information of the broadcast network and to provide network information including the broadcast service area information to the content provider system facilitating an understanding of the broadcast network by the content provider system without disclosing configuration details of the broadcast network to the content provider system; and
provide, by the gateway interface in response to a request for the broadcast service area information from the content provider system, a broadcast service area response message comprising at least a portion of the network information to the content provider system, wherein the at least a portion of the network information includes the broadcast service area information.

17. The non-transitory computer-readable medium of claim 16, wherein the program code further comprises program code executable by a computer for causing the computer to:
conduct a service negotiation data exchange to initiate one or more service in the broadcast network by the content provider system, wherein the request for the broadcast service area information and the broadcast service area response message are part of the service negotiation data exchange.

18. The non-transitory computer-readable medium of claim 16, wherein the program code further comprises program code executable by a computer for causing the computer to:
receive, by the gateway interface, a service request message provided by the content provider system, wherein the service request message specifies one or more attributes with respect to a service to be provided, and wherein at least a portion of the one or more attributes are based upon the at least a portion of the network information provided in the broadcast service area response message.

19. An apparatus configured for interfacing a content provider system with a broadcast network, the apparatus comprising:
a memory; and
at least one processor coupled to the memory, the at least one processor configured:
to interface the content provider system to a gateway configured to enable the content provider system to request broadcast service area information of the broadcast network and to provide network information including the broadcast service area information to the content provider system facilitating an understanding of the broadcast network by the content provider system without disclosing configuration details of the broadcast network to the content provider system; and
to provide, by the gateway interface in response to a request for the broadcast service area information from the content provider system, a broadcast service area response message comprising at least a portion of the network information to the content provider system, wherein the at least a portion of the network information includes the broadcast service area information.

20. The apparatus of claim 19, wherein the at least a portion of the network information includes broadcast service area information providing data regarding one or more geographic areas covered by the broadcast network including a broadcast service area polygon and a plurality of member polygons, wherein the broadcast service area polygon describes a series of points defining an outer geographic boundary of a broadcast service area encompassing the plurality of member polygons, and wherein each member polygon of the plurality of polygons describes a series of points defining an outer geographic boundary of a portion of the broadcast service area having particular demographic attributes and reception condition and device type pairings.

21. The apparatus of claim 19, wherein the at least a portion of the network information includes data regarding network coverage provided within the broadcast service area including a percentage coverage at a specific service grade for supported services within the broadcast service area.

22. The apparatus of claim 19, wherein the at least a portion of the network information includes data regarding network coverage provided within the broadcast service area including data regarding currently reachable receivers in the broadcast service area.

23. The apparatus of claim 22, wherein the data regarding currently reachable receivers in the broadcast service area comprises numbers and types of the currently reachable receivers in the broadcast service area.

24. The apparatus of claim 23, wherein the data regarding network coverage provided within the broadcast service area comprises numbers and types of potentially reachable receivers in the broadcast service area, wherein the potentially reachable receivers are present on a specific service although not currently engaging in reporting connectivity.

25. The apparatus of claim 19, wherein the at least a portion of the network information includes data regarding network coverage provided within the broadcast service area including data regarding demographics for users in the broadcast service area.

26. The apparatus of claim 19, wherein the request from the content provider for the broadcast service area information and the broadcast service area response message by the gateway including the broadcast service area information invoke a RESTful API for the gateway interface on resources and associated properties managed by a network operator of the broadcast network, wherein the RESTful API implements HTTP methods and corresponding HTTP responses.

27. The apparatus of claim 19, wherein the at least one processor is further configured:
to conduct a service negotiation data exchange to initiate one or more services in the broadcast network by the content provider system, wherein the request for the broadcast service area information and the broadcast service area response message are part of the service negotiation data exchange.

28. The apparatus of claim 19, wherein the at least one processor is further configured:
to receive, by the gateway interface, a service request message provided by the content provider system, wherein the service request message specifies one or more attributes with respect to a service to be provided, and wherein at least a portion of the one or more attributes are based upon the at least a portion of the network information provided in the broadcast service area response message.

29. The apparatus of claim 28, wherein the at least one processor is further configured:
to provide, by the gateway interface, a service offer message to the content provider system, wherein the service offer message comprises information regarding attributes with respect to a service that the broadcast network is able to support, wherein one or more of the attributes of the service offer message differ from one or more corresponding attributes of the service request message; and
to receive, by the gateway interface, a revised service request message provided by the content provider system, wherein the revised service request message specifies one or more attributes with respect to a service to be provided, and wherein at least a portion of the one or more attributes are based upon the information regarding attributes with respect to the service that the broadcast network is able to support provided in the service offer message.

30. The apparatus of claim 29, wherein the service request message, the service offer message, the revised service request message, and responses to each of the service request message, service offer message, and revised service request message are provided using HTTP methods in accordance with defined operations on a RESTful API of the gateway interface.
